(19) United States
(12) Patent Application Publication
(10) Pub. No.: US 2013/0284027 A1
(43) Pub. Date: Oct. 31, 2013

(54) CONTAINER DATA CENTER

(71) Applicant: FENG-CHI YANG, Tu-Cheng (TW)

(72) Inventor: FENG-CHI YANG, Tu-Cheng (TW)

(73) Assignee: HON HAI PRECISION INDUSTRY CO., LTD., Tu-Cheng (TW)

(21) Appl. No.: 13/491,574

(22) Filed: Jun. 7, 2012

(30) Foreign Application Priority Data
Apr. 27, 2012 (CN) 201210126782.4

(51) Int. Cl. B01D 47/02; B01D 53/26

(52) U.S. Cl. 96/329

(57) ABSTRACT

A container data center includes a container and an air purification device. The air purification device includes an air inlet, a dissolution unit, and a separation unit. The dissolution unit receives dissolution liquid. The air that comes from the air inlet flows through the dissolution liquid, so that salt in the air may dissolve into the dissolution liquid. The air that comes from the dissolution unit flows through the separation unit, to dry the air. The dried air then flows into the container.

### BACKGROUND

1. Technical Field

The present disclosure relates to a container data center.

2. Description of Related Art

When a container data center is positioned in an area of high salinity, such as a seashore area, the salty air could get into the container, which may corrode the electronic devices in the container.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an assembled, schematic view of a container data center, according to a first exemplary embodiment.

FIG. 2 is an assembled, schematic view of a container data center, according to a second exemplary embodiment.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

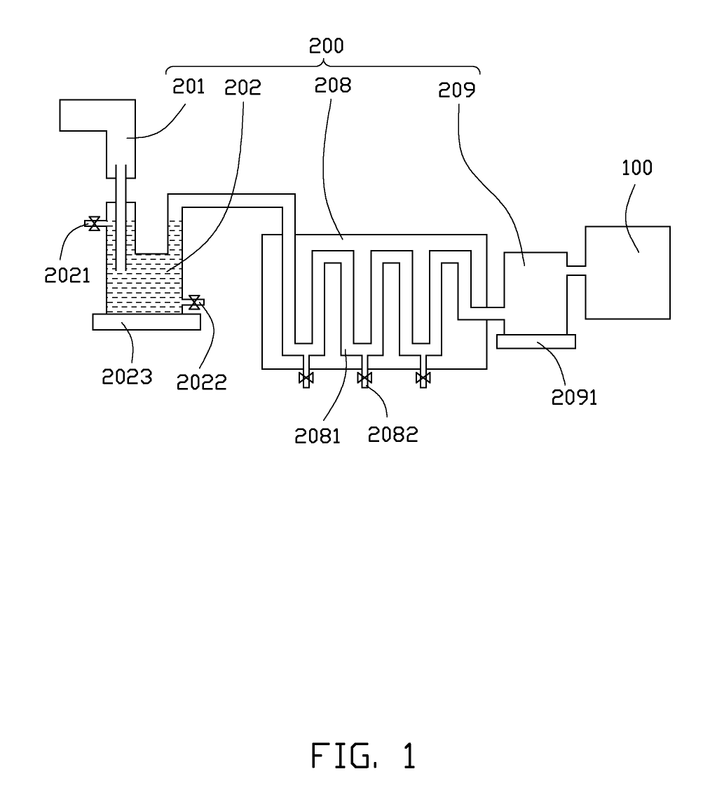

Referring to the FIG. 1, a first embodiment of a container data center includes a container 100 and an air purification device 200. A plurality of electronic devices (not shown) is arranged in the container 100.

The air purification device 200 includes an air inlet 201, a dissolution unit 202, a separation unit 208, and a heating unit 209.

The air inlet 201 receives a plurality of fans for drawing in air.

The dissolution unit 202 contains dissolution liquid for dissolving the salt in the air coming from the air inlet 201. The dissolution liquid may be water or other liquid which can easily dissolve the salt. The dissolution unit 202 includes a dissolution liquid inlet 2021 for loading new dissolution liquid, a dissolution liquid outlet 2022 for discharging used dissolution liquid, and a heating plate 2023 for heating the dissolution liquid to accelerate dissolving the salt.

The separation unit 208 includes an air cooling pipe 2081. The airflow from the dissolution unit 202 is cooled in the cooling pipe 2081, then the water vapor in the air is separated to dry the airflow. The air cooling pipe 2081 includes a plurality of water outlets 2082 for discharging the water separated from the airflow.

The heating unit 209 includes a heating plate 2091 for heating the airflow from the separation unit 208 to normal atmospheric temperature. The airflow then flows into the container 100.

In this embodiment, the air purification device 200 can filter the salt from the air flowing into the container 100, which can prevent the electronic devices in the container 100 from corroding do to salt air. Furthermore, the heating unit 209 can be omitted, allowing the cooled airflow from the separation unit 208 to directly flow into the container 100 to aid in cooling the electronic devices in the container 100.

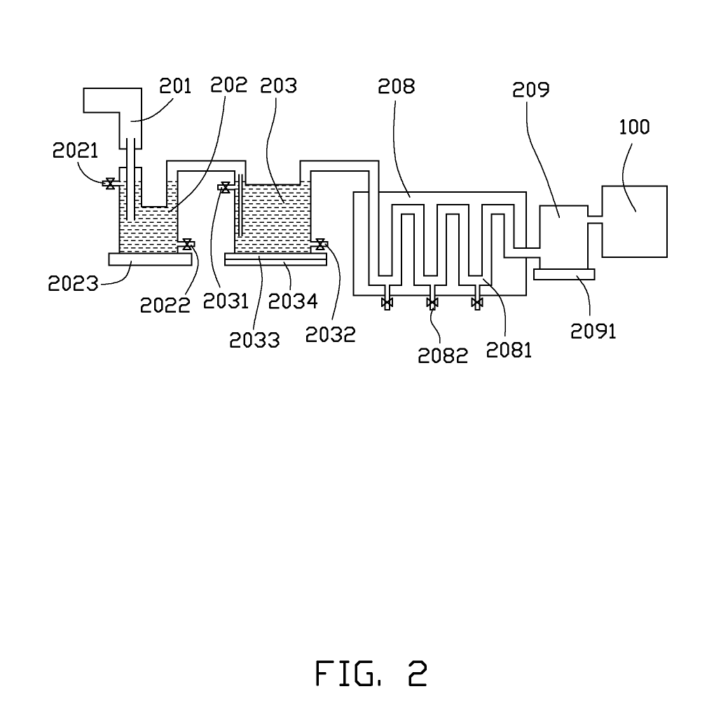

FIG. 2 shows a second embodiment of a container data center. In contrast with the first embodiment, the second embodiment of the container data center includes an assistant dissolution unit 203 between the dissolution unit 202 and the separation unit 208.

The assistant dissolution unit 203 contains dissolution liquid for dissolving any remaining salt in the air coming from the dissolution unit 202. The dissolution liquid may be water or other liquid which can easily dissolve the salt. The assistant dissolution unit 203 includes a dissolution liquid inlet 2031 for loading new dissolution liquid, a dissolution liquid outlet 2032 for discharging used dissolution liquid, a heating plate 2033 for heating the dissolution liquid, and a shaking plate 2034 for shaking the dissolution liquid, to accelerate dissolving the salt.

If the salinity in the air is overly high, the air purification device 200 may include more assistant dissolution units 203 between the dissolution unit 202 and the separation unit 208, to better filter out the salt.

Even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A container data center, comprising:
a container; and
an air purification device comprising an air inlet, a dissolution unit, and a separation unit, wherein the dissolution unit contains dissolution liquid, the air coming from the air inlet flows through the dissolution liquid, so that the salt in the air is dissolved in the dissolution liquid, the air coming from the dissolution unit flows through the separation unit, to be dried, then the dried air flows into the container.

2. The container data center of claim 1, wherein the dissolution unit comprises a dissolution liquid inlet for loading new dissolution liquid, a dissolution liquid outlet for discharging used dissolution liquid.

3. The container data center of claim 2, wherein the dissolution unit further comprises a heating plate for heating the new dissolution liquid.

4. The container data center of claim 1, wherein the separation unit comprises an air cooling pipe, the airflow from the dissolution unit is cooled in the cooling pipe, then water vapor in the air is separated to dry the airflow.

5. The container data center of claim 4, wherein the cooling pipe comprises a plurality of water outlets for discharging the water separated from the airflow.

6. The container data center of claim 1, wherein the air purification device further comprises a heating unit between the container and the separation unit, for heating the airflow, the heated airflow then flows into the container.

7. The container data center of claim 1, wherein the air purification device further comprises an assistant dissolution unit between the dissolution unit and the separation unit, the assistant dissolution unit contains dissolution liquid for dissolving the salt in the airflow coming from the dissolution unit.

8. The container data center of claim 7, wherein the assistant dissolution unit comprises a dissolution liquid inlet for loading new dissolution liquid, a dissolution liquid outlet for discharging used dissolution liquid, a heating plate for heating the dissolution liquid, and a shaking plate for shaking the dissolution liquid, to accelerate dissolving the salt.
